(19) United States
(12) Patent Application Publication
(10) Pub. No.: US 2013/0232426 A1
(43) Pub. Date: Sep. 5, 2013

(54) SYSTEM AND METHOD FOR CREATING AND MANAGING DYNAMIC PROPOSITIONS FOR ONLINE COMMUNITY FEEDBACK

(71) Applicants: Geoffrey Rego, Cupertino, CA (US); Vijay Dendukuri, Vijayawada (IN); Stephen Pieraldi, San Bruno, CA (US); Sridhar Gunapu, Santa Clara, CA (US)

(72) Inventors: Geoffrey Rego, Cupertino, CA (US); Vijay Dendukuri, Vijayawada (IN); Stephen Pieraldi, San Bruno, CA (US); Sridhar Gunapu, Santa Clara, CA (US)

(73) Assignee: GuessN LLC, Cupertino, CA (US)

(21) Appl. No.: 13/410,666

(22) Filed: Mar. 2, 2012

(51) Int. Cl. G06F 3/048; G06F 15/16

(52) U.S. Cl. 715/751

(57) ABSTRACT

Systems and methods for creating and managing dynamic propositions for online community feedback are provided. Example embodiments include, providing a user interface, by use of a processor, to enable a creator to create a proposition; inserting tags into variable portions of the proposition to parameterize the proposition; identifying a target audience for the parameterized proposition; and publishing the parameterized proposition to the identified target audience.

### TECHNICAL FIELD

The inventive subject matter relates generally to data and social networks and more specifically to systems and methods for creating and managing dynamic propositions for online community feedback.

### BACKGROUND

It is often beneficial to be able to query a group of people about an issue of interest. For example, marketers or advertisers often use focus groups to solicit feedback regarding advertising or product offerings. Increasingly, data and social networks are being used to solicit feedback from a group or community of online users. There are at least two conventional ways that are being used to solicit feedback from a community of online users: 1) surveys, and 2) ad hoc comments.

In regard to the conventional use of surveys, let's say a magazine wants to survey the results of an upcoming event like the superbowl. The current methods to do this would create a question with a list of possible choices and a free form text field for ‘Other’ like the following:

Who will win the 2012 super bowl?
a) 49'ers
b) Patriots
c) Giants
d) Other [Please specify]

Given the question presented in the above example, respondents would pick a choice or fill in their preferred choice. The (d) choice would require unstructured text input. The limitations with this conventional approach include:
The list of valid choices are chosen by the surveyor, hence the list of choices can be biased.
The ‘Other’ option is free-form text and does not expose other user-contributed choices as options.
The question presented, as in the above example, can only be used to track one dimensional responses. E.g., If you need to survey Team & Year, this is not possible in conventional surveys.
The survey cannot identify influencing users in the respondents.

Other aspects of a survey attempt to solve these issues by allowing participants to have discussions or comments attached to the choices listed. These comments suffer a number of deficiencies. Comments and discussions, when used to derive secondary data, are ineffective, inaccurate and often so far off topic the data set is effectively useless. Other structural deficiencies in a survey process are: the proposition does not allow for structured input controls. Machine learning and dynamic interaction with the users are not part of the operational control set. There is not a logical way to construct and manage an ontological tree from the comment or “other” field. This leaves the post processing of data to incorrectly resolve conflicts or eliminate potentially valuable or critical data.

Ad hoc comments are a popular way to discuss a topic or express opinion in an ad hoc fashion on various entities online. These comments could be linear or threaded in nature. While this approach has its advantages, the downsides are that the discussion could veer off topic with each comment and depth of the comment tree. It is also hard for a machine to digest the comment list to determine attributes such as sentiment, consensus, opinion etc. Additionally, these systems are not an inbound fitter and management methodology, but are a post-input data management system. The resulting loss of data due to bad data structure is a critical weakness.

### BRIEF DESCRIPTION OF THE DRAWINGS

Some embodiments are illustrated by way of example and not limitation in the figures of the accompanying drawings in which:

FIG. 1 is a high-level diagram depicting an example client/server system within which an example embodiment may be implemented;

FIGS. 2A and 2B are process flow diagrams illustrating a processing flow in an example embodiment;

FIGS. 3 through 7 are sample screen shots illustrating an example embodiment of a user interface for processing a proposition;

FIG. 8 illustrates an example data structure of an example embodiment;

FIG. 9 illustrates the multidimensional voting analysis options in an example embodiment;

FIG. 10 illustrates a cause/effect (fishbone) diagram in an example embodiment;

FIG. 11 is a processing flow diagram illustrating the process flow in an example embodiment;

FIG. 12 is a block diagram illustrating a diagrammatic representation of a machine in the example form of a computer system.

### DETAILED DESCRIPTION

Example systems and methods for creating and managing dynamic propositions for online community or social network feedback are described. In the following description, for purposes of explanation, numerous specific details are set forth in order to provide a thorough understanding of example embodiments. It will be evident, however, to one skilled in the art that the present invention may be practiced without these specific details.

### Overview

In the various example embodiments described herein, rifling is used to solicit online community feedback regarding a topic of interest. As described herein, “riffing” is a method of gathering user (e.g., an online community, or social network, or the Crowd) opinions by seeding a set of initial propositions, which can then be altered by the recipients. As used herein, a proposition (also denoted herein as an assertion, a question, topic statement, or other statement intended to solicit or encourage responses from one or more users of an online community. As described herein, a mechanism is provided for a marketer or other feedback aggregator to survey user opinions by presenting users (‘the Crowds’) with an assertion that the Crowd can respond to or modify to make it factual from their point of view. A system-controlled environment is provided and used to create derivative propositions in context or relative context of the original proposition. The system controls and manages among other things, the visibility, targeting, distribution, proposition modification, data input, analytics, ontological matching and the lifecycle of a given proposition. This new implementation is in contrast to any conventional systems that use comments as a method to option input on a given proposition. In a particular embodiment, rifling can have voting validation or not. It may have as much or as little control as the system variable specify.

In the various embodiments described herein, the surveyor can make an initial proposition or multiple propositions around an idea or topic of interest. The surveyor can also tag the proposition with some meta data to enable respondents to change certain parts of the proposition. This gives the system additional semantic knowledge about the structure and context of the proposition. In the examples presented herein, we will use braces “[ ]” as markers for variables in the proposition. Braces are a proxy for any method that identifies user-modifiable portions or fields in a proposition. In alternative embodiments, the variable portions of a proposition could be identified with braces, brackets, quotes, or any other reserved command symbols. An example proposition with variable elements is set forth below:
Initial Proposition: [49'ers] will win the [2012] super bowl.

In this example, the variable elements, “49'ers” and “2012” are user modifiable. A proposition, such as the example proposition shown above, can be initially proposed or submitted by a proposition creator. Once the proposition is created, the proposition can be distributed electronically via various social networks or web/mobile services to various recipients (e.g., one or more users of an online community or the Crowd). The various recipients receiving the proposition can choose to respond or not. When the respondent sees a proposition, they can either Agree or Disagree with it. The act of agreement is expressed in an affirmative vote.

The act of disagreement is expressed in a negative vote. Whether an affirmative or negative vote is submitted by the respondent, the system offers the respondent the opportunity to riff on the assertion. Respondents can choose to vote and not create a riff. If the respondent chooses to riff, the respondent is then presented with a user interface (UI) enabling the respondent to alter the user-modifiable variables set in the proposition by the proposition creator. Depending on the configuration of the user-modifiable variables set in the proposition by the proposition creator, the respondent can view all possible values of a particular user-modifiable variable as presented in a lookup table. In this case, the proposition creator has created an enumerated set of responses. In other configurations, the proposition creator can configure a particular user-modifiable variable as free-form input element, a particularly formatted input element (e.g., a date, time, or currency value, etc.), or other form of desired response type. The user-modifiable variables can capture any input provided by a respondent as part of a riff. The respondent can riff on the initial proposition by choosing a provided value option in a particular user-modifiable variable or adding a new value in a particular user-modifiable variable as long as the option to riff on the proposition remains open for actions. The following example shows how several users can riff on the sample proposition set forth above:
Initial Proposition: [49'ers] will win the [2012] super bowl.
User 1: Ok
User 2: [49'ers] will win the [2012] super bowl.
   Giants will win the 2012 super bowl
User 3: [49'ers|Giants] will win the [2012] super bowl.
   Cowboys will win the 2013 super bowl
User 4: [49'ers|Giants|Cowboys] will win the [2012|2013] super bowl.
   49'ers will win the 2013 super bowl

In the example shown above, the ‘Team’ variable [49'ers] has at least three choices: [49'ers, Cowboys, Giants], The ‘Year’ variable [2012] has at least two choices: [2012, 2013]. These user-modifiable variable value options can be configured by the proposition creator when the proposition is initially created. This enables the proposition creator to retain some level of control over the direction in which the respondents can riff on the proposition.

The various embodiments described herein provide a system for creating and managing dynamic propositions for online community feedback. The system in particular embodiments can provide a variety of features and insights including:
The system can capture multiple variables with one statement. In the example above, we captured two dimensions (Teams and Year) in one simple statement. Additional dimensions could also have been captured.
The system can track the evolution of a proposition and collect statistics on user agreement/opinion on each variation of the proposition. It may be that a user disagrees with a particular assertion, but could agree to some variation of it that some other user has expressed.
The system can discover value sets. We have discovered values from the Crowd instead of presenting them with a packaged set of choices.
The system can provide conditional variables. We can modify the variables that can be changed based on respondent profile thereby letting us correlate common variable data with the conditional variable data.
The system can identify influencing ideas and influencers. We can track an assertion tree in the way in which it morphs and see which riffer influences others the most.
The system can track variations over time. For example, as we get closer to an event some new values might appear.
The system can provide profile based sorting that is dynamically associated to the presentation artifact
The system can provide linking of similar or near neighbor propositions in the database as a user creates a riff. For example, a multiword select so significantly modifies the proposition as to appear like another in the system.
The system can restrict a proposition and the related Crowd participation to be localized to specific locations. E.g., people only physically present at a particular bar can participate in a proposition. These are considered location-based propositions.
The system can provide structured seeding of new propositions or as suggestions to other threads providing phases and shift data values in association with the original proposition.

Rifling provides a mechanism for the proposition creator to express the topic of contention as a proposition and eliminate free form comments altogether. As users riff on each other's propositions, they essentially are ‘Replying’ to an existing Proposition (Comment). The system keeps track of the replies and the users in the database which can then be used to generate summaries, decisions, comparisons, and consensus views by analyzing votes and the various values of the variables generated by the users. An Analytics module provides functionality for identifying, extracting, correlating and analyzing assertions and their associated riff's by parsing the data captured and analyzing the data across different dimensions to provide unparalleled business insight and intelligence.

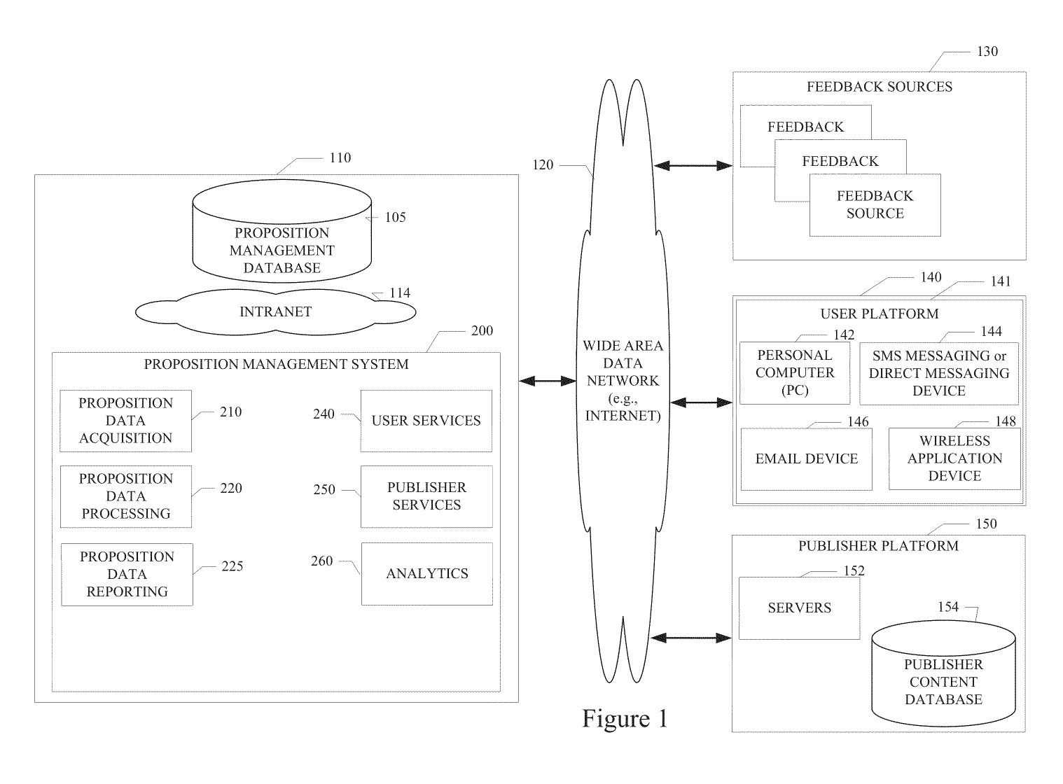

FIG. 1 is a high-level diagram depicting an example client/server system within which an example embodiment may be implemented. Referring to FIG. 1, in an example embodiment, a system for creating and managing dynamic propositions for online community feedback are disclosed. In various example embodiments, an application or service, typically operating on a host site (e.g., a website) 110, is provided to simplify and facilitate proposition management for a user at a user platform 140 from the host site 110. The host site 110 can thereby be considered a proposition management site 110 as described herein. Multiple feedback sources 130 correspond to a plurality of networked (online) users who may receive and vote on a particular proposition. The feedback sources 130 correspond to the Crowd as described herein. One or more of the parameterized propositions can be provided by one or more publishers operating at publisher platforms 150. It will be apparent to those of ordinary skill in the art that feedback sources 130 and user platform 140 can also be used to send and/or receive parameterized propositions. The proposition management site 110, feedback sources 130, user platforms 140, and publisher platforms 150 may communicate and transfer propositions and information via a wide area data network (e.g., the Internet) 120. Various components of the proposition management site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art. Furthermore, remote computers and other related electronic devices can be remotely connected to either LANs or WANs via a modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

In a particular embodiment, a user platform 140 with one or more client devices 141 enables a user to send or receive propositions to/from the feedback sources 130 via the network 120. Client devices 141 may include virtually any computing device that is configured to send and receive information over a network, such as network 120. Such client devices 141 may include portable devices 144 or 146 such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message.

Client devices 141 may also include at least one client application that is configured to send or receive propositions or messages from another computing device via a network transmission. The client application may include a capability to provide and receive textual content, graphical content, video content, audio content, alerts, messages, notifications, and the like. Moreover, client devices 141 may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Client devices 141 may also include a wireless application device 148 on which a client application is configured to enable a user of the device to subscribe to a service for managing propositions. Such subscription enables the user at user platform 140 to send or receive through the client device 141 at least a portion of content related to a parameterized proposition. Such content may include, but is not limited to, instant messages, Twitter tweets, posts, stock feeds, news articles, personal advertisements, shopping list prices, images, search results, blogs, sports, weather reports, or the like. Moreover, the content may be provided to or received from client devices 141 using any of a variety of delivery mechanisms, including IM, SMS, Twitter, Facebook, MMS, IRC, EMS, audio messages, HTML, email, or another messaging application. In a particular embodiment, the application executable code used for content subscription as described herein can itself be downloaded to the wireless application device 148 via network 120. A widget or plug-in or link can be embedded on other websites or social media sites, wherein the embedded widget or plug-in or link can enable users to riff on propositions.

The publisher platform 150 represents a particular proposition creator, which may be any one of the feedback sources 130. As with any of the feedback sources 130, publisher platform 150 can include a data storage device or database of publisher content 154 and one or more servers 152 to serve that content to users at user platforms 140 via network 120.

Referring still to FIG. 1, host site 110 of an example embodiment is shown to include a proposition management system 200, intranet 114, and proposition management database 105. Proposition management system 200 includes proposition data acquisition module 210, proposition data processing module 220, proposition data reporting module 225, analytics module 260, user services module 240, and publisher services module 250. Each of these modules can be implemented as software components executing within an executable environment of proposition management system 200 operating on host site 110. Each of these modules of an example embodiment is described in more detail below in connection with the figures provided herein.

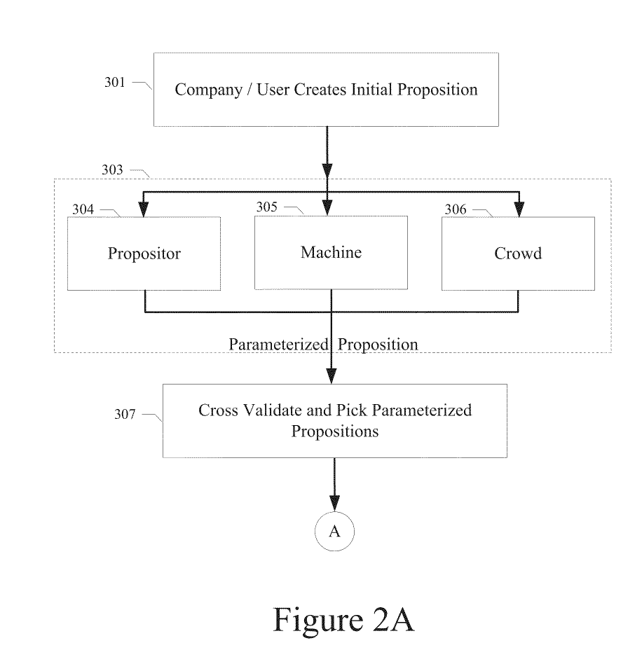

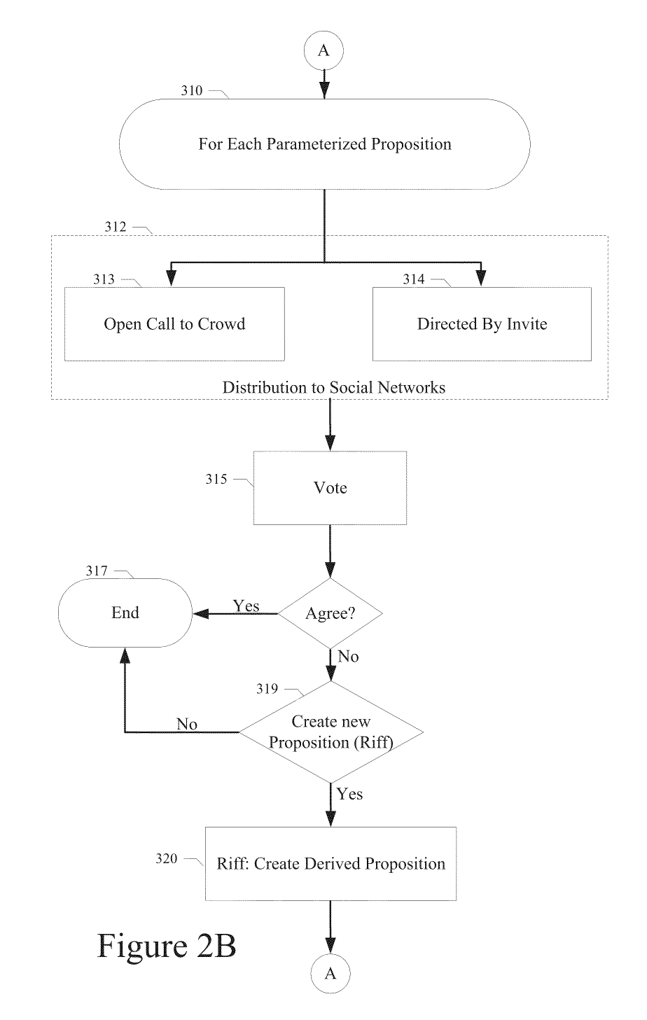

Referring now to FIGS. 2A and 2B, process flow diagrams illustrate a processing flow in an example embodiment. Referring to FIG. 2A, a surveyor or proposition creator can create a set of propositions in the topic/subject they would like to survey (block 301). At block 303, the system then provides three ways of identifying the variables in the proposition to track:

a) the surveyor can manually tag the proposition with the variables they would like to track (block 304). This done by surrounding the variable words with square brackets (or other pre-defined symbol);

b) the system can identify variables based on a combination of various pre-defined functions or rules (block 305). For example, the pre-defined functions may include the following:
Stop word method. Commonly occurring word sets are used to filter out common words and to identify interesting phrases. Numbers, Quantities and dates are identified as variables.
NER: Named Entity Recognition. We apply NER recognition models to the proposition to identify named entities, which become variables. The NER models are built from existing data in the system and historical news/headline datasets.
Rule based lookup: We create NGrams of out the proposition and match them against well knows topics, people, location, entity names databases.

c) Ask a subset of the users (the Crowd) selected based on past performance to restate the proposition and tag the variables (block 306).

At block 307, the system enables the surveyor or proposition creator to select the final list of parameterized propositions to be targeted and distributed for responses from the Crowd. Processing continues at the bubble labeled ‘A’ as shown in FIG. 2B.

Referring now to FIG. 2B, proposition processing in an example embodiment continues at the bubble labeled ‘A’. At processing element 310, a loop is started to process each of the parameterized propositions created by the proposition creator as described above. For each parameterized proposition, the system can employ at least two methods (block 312) for identifying a target audience and distributing the parameterized proposition to the Crowd: 1) an ‘Open Call to the Crowd’ option (block 313), and 2) a ‘Directed by Invite’ option (block 314). The ‘Open Call to the Crowd’ option enables anyone in the Crowd be a respondent. The ‘Directed by Invite’ option enables the surveyor or proposition creator to select a target audience using rules like age group, income level, etc. and to send an invite for participation to the target audience.

At block 312, the parameterized proposition can be distributed to the Crowd or the target audience. The distribution mechanism can be via website, mobile, sms, email, twitter, social network services, custom messaging services, etc. When the recipient gets the parameterized proposition, the recipient can either Agree or Disagree with the parameterized proposition (block 3150. If the recipient agrees with the parameterized proposition, their preference is logged (block 317). If the recipient disagrees with the parameterized proposition, their preference is logged and the recipient is presented with an option to change the proposition variables to their liking (block 319). If the recipient chooses to change the initial proposition (i.e., Create a Riff), a new derived proposition with their values is created and linked as a child to the initial proposition (block 320). The Riff is then sent to the original target audience so they can voice their opinion on the derived proposition. As such, processing loops back to the bubble labeled ‘A’ as shown in FIG. 2B.

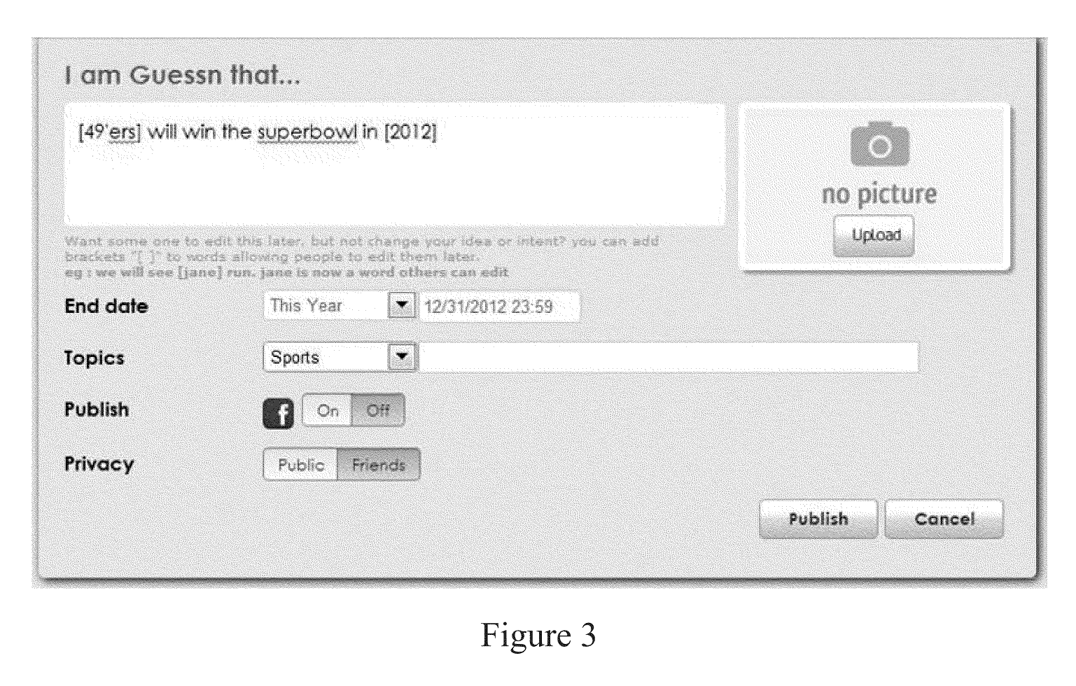

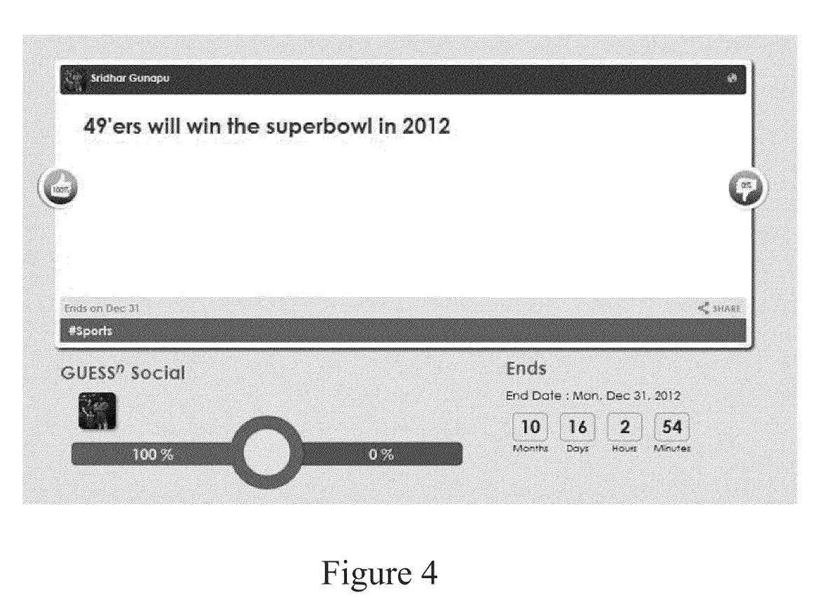

Referring now to FIGS. 3 through 7, sample screen shots illustrate an example embodiment of a user interface for processing a proposition. Referring to FIGS. 3 and 4, a surveyor or proposition creator can create a parameterized proposition as described above. The parameterized proposition can then be distributed to the Crowd or the target audience.

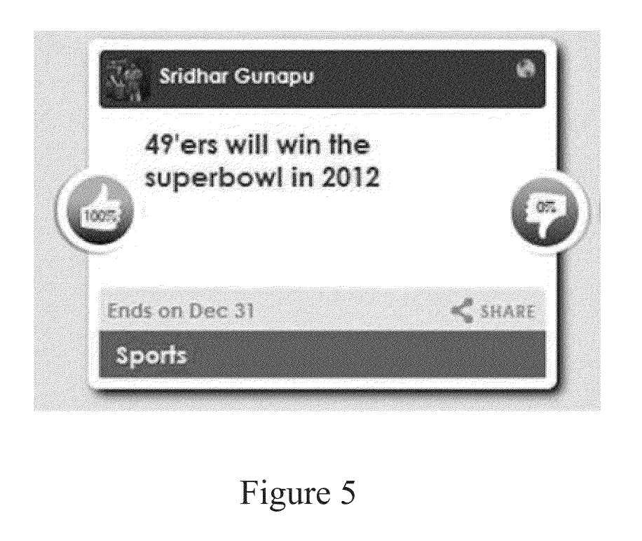

Referring to FIG. 5, a respondent receives the parameterized proposition in their inbox (e.g., website, email, social network stream, etc.). The respondent can vote on the parameterized proposition by clicking Thumbs Up or Down icons as shown in FIG. 5.

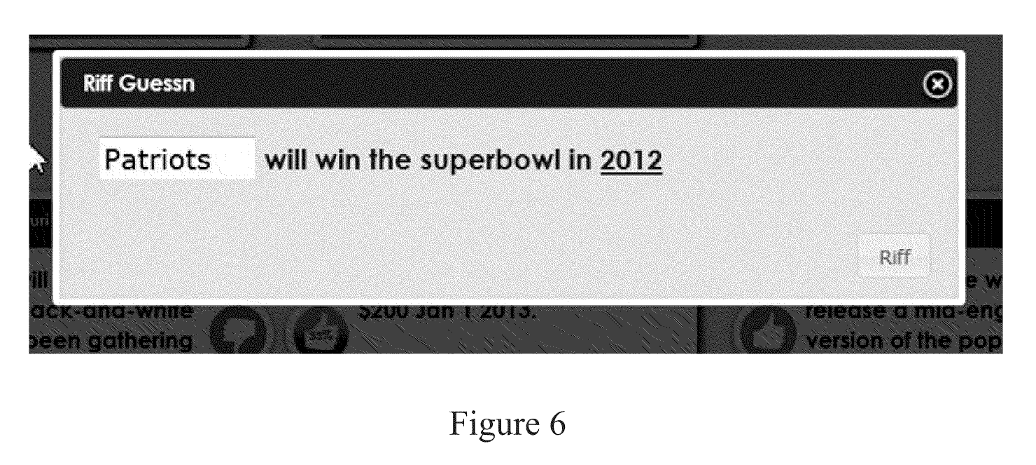

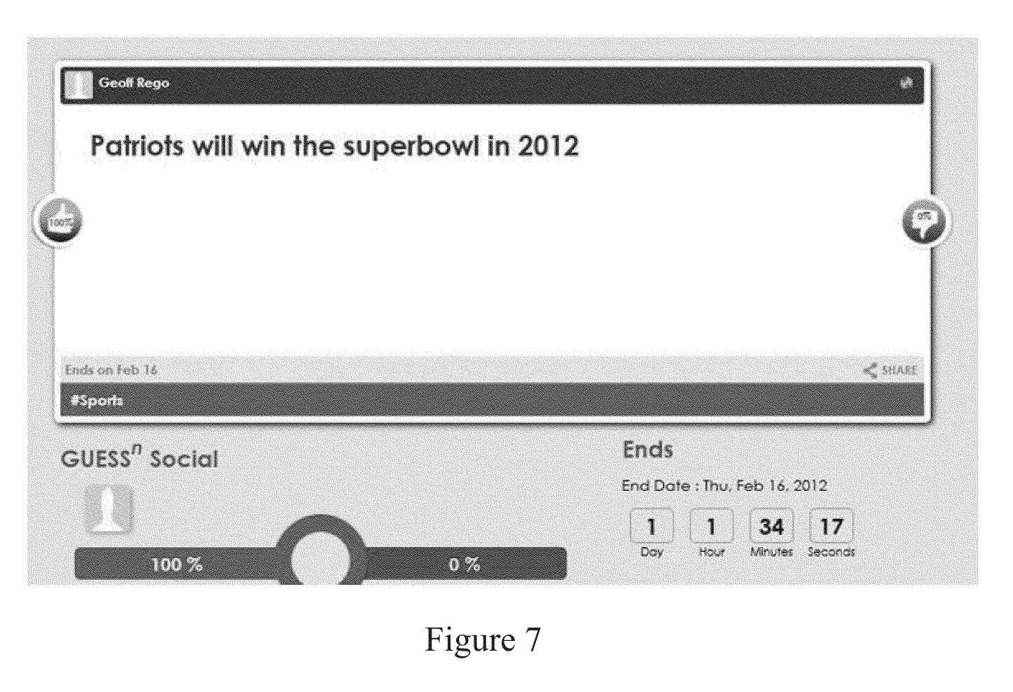

Referring to FIGS. 6 and 7, the respondent is presented with an option to riff on the parameterized proposition. The respondent can riff on the original proposition by modifying the parameterized portions of the original proposition and resubmit the modified proposition to the Crowd or the target audience. The riff (modified proposition) is now visible to the same group as the original parameterized proposition and can be voted on or riffed on yet again.

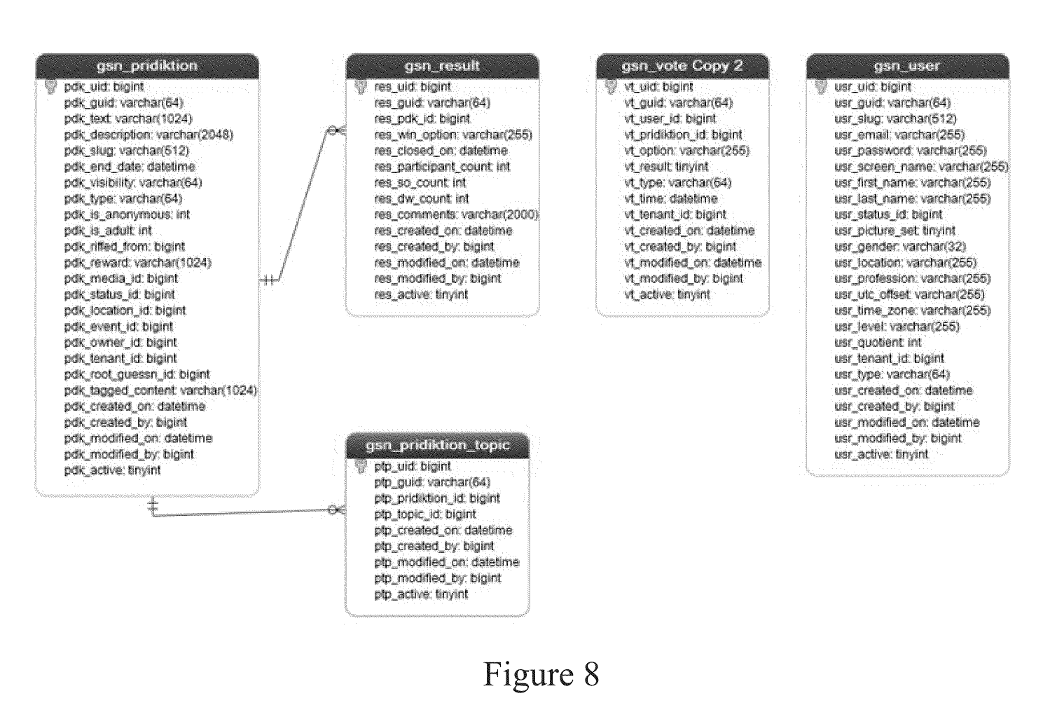

FIG. 8 illustrates an example data structure of an example embodiment.

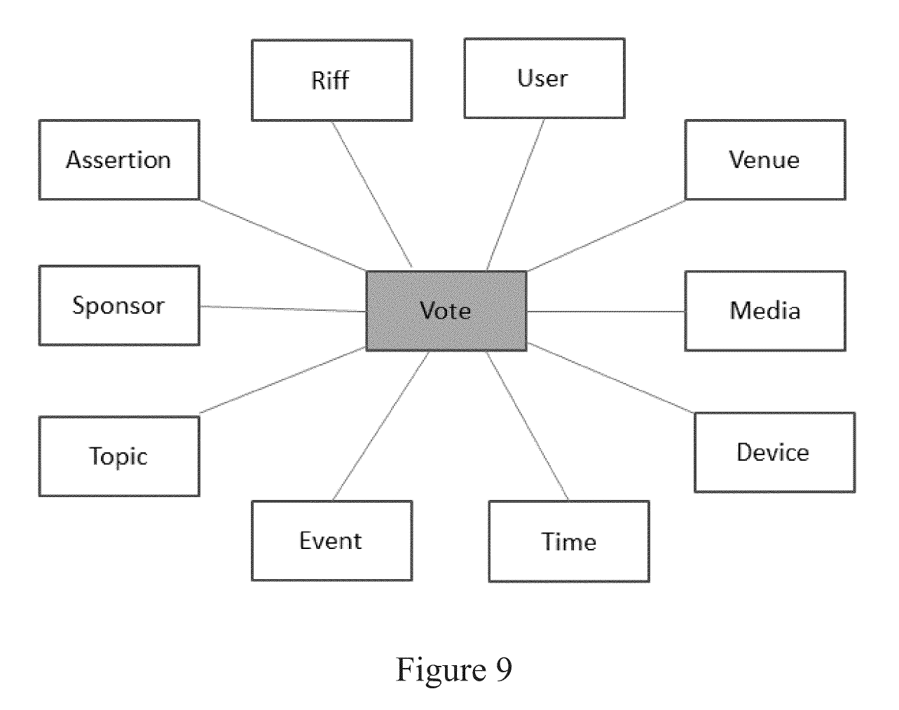

FIG. 9 illustrates the multidimensional voting analysis of propositions in an example embodiment.

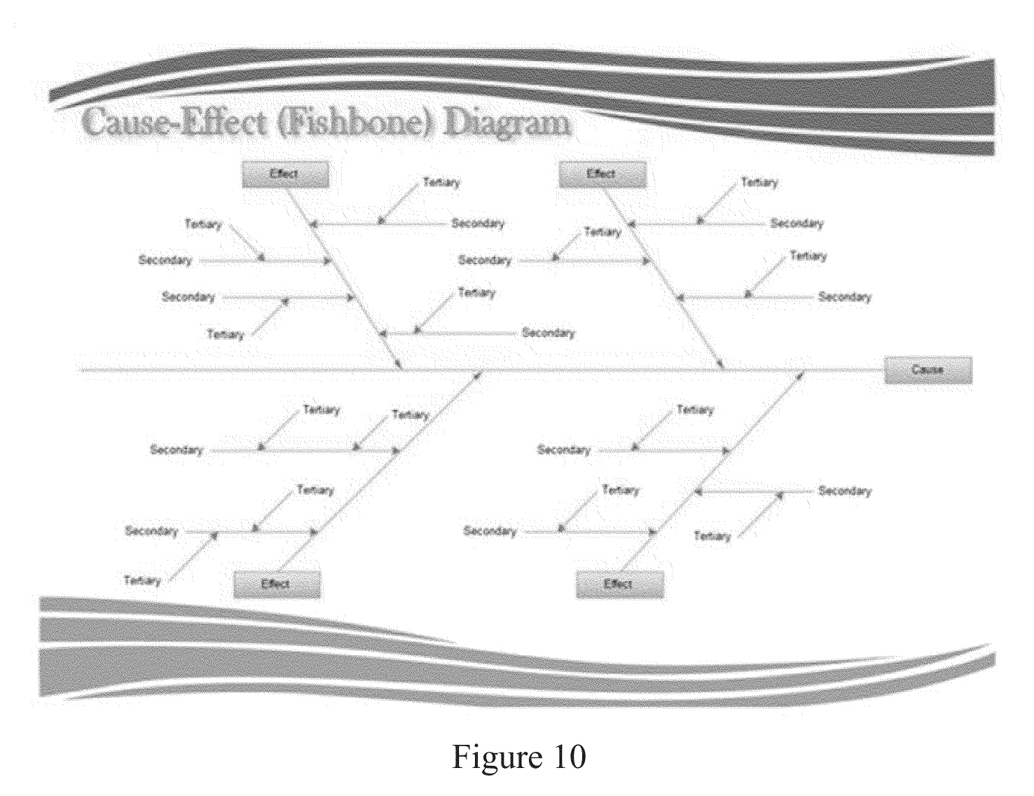

FIG. 10 illustrates a cause/effect (fishbone) diagram in an example embodiment. In FIG. 10, a cause corresponds to data, and the effect corresponds to words set as variables. Secondary and tertiary words are user inputs. In an example embodiment, one can parametrically assign weights and constraints to each branch. We further sort presentation of secondary and tertiary branches in assigned profile and psychographic mappings. This gives one a unique and controlled flow that feeds our relationship metadata. This would create velocity values between effects, which can be expressed in a formula tracking how the social graph moves with the subsequent entries. For example, a given word effect is set and there are X number of secondary words created. As the rate of creation slows in favor of a given set of words set to the effect, then one can track the velocity of those words which may or may not change in time to cause. One can also see how a slowed or stalled velocity starts again as other effects take shape. In the end, when the date of close triggers, one will have a set of data tracking word variance, proposition variance, selection rate and change variance, applied effect of horizontal and vertical impacts to sets of secondary and tertiary adoptions. All this, before the “answer,” is known in direct contrast to the survey method, which does not have access to the motion and parametric relevance of interactions against or for the original proposition. Therefore, one can see how the fishbone model better sets the stage for us to process dynamic propositions. The dynamic proposition processing embodiments described herein provide a better machine method of control and measurement versus the post processing methods often deployed in survey technology.

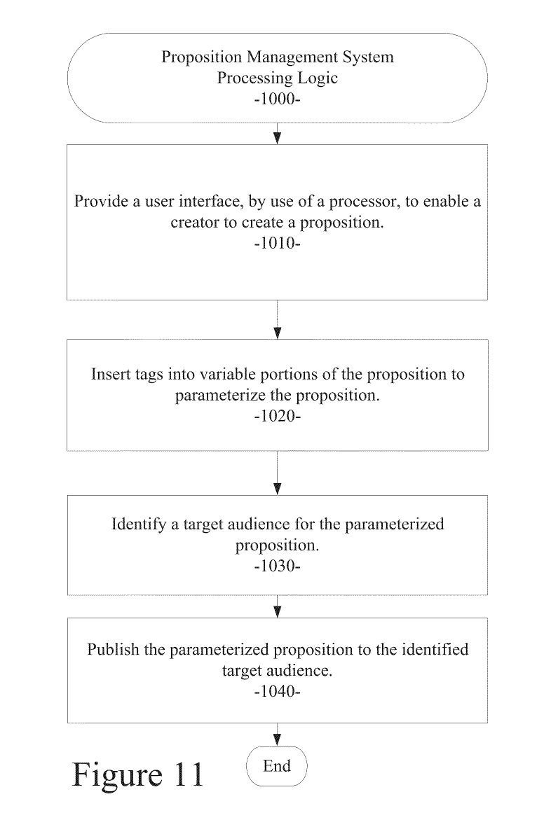

FIG. 11 is a processing flow diagram illustrating the process flow in an example embodiment. An example embodiment of the process flow includes: providing a user interface, by use of a processor, to enable a creator to create a proposition (processing block 1010); inserting tags into variable portions of the proposition to parameterize the proposition (processing block 1020); identifying a target audience for the parameterized proposition (processing block 1030); and publishing the parameterized proposition to the identified target audience (processing block 1040).

An example embodiment of the process flow further includes: providing a user interface, by use of a processor, to enable a respondent to receive a parameterized proposition: prompting the respondent to vote on the parameterized proposition; logging a vote submitted by the respondent; enabling the respondent to modify variable portions of the parameterized proposition as identified by tags in the parameterized proposition; and publishing the modified parameterized proposition to a target audience.

Another example embodiment of the process flow further includes: creating a proposition and parameterizing it by tagging variable parts with open & close square brackets and adding a picture if appropriate; setting up an end date; categorizing the parameterized proposition into a topic; adding additional tags: selecting if the parameterized proposition should be distributed on Facebook and/or other social networks; selecting if this is an Open Call or by Invite Only proposition; and publishing the parameterized proposition to the Crowd. A Publisher can also restrict a proposition to a specific location and/or venue. For example, a publisher can restrict a proposition to a Crowd of only users within 100 feet of where proposition is created.

Additionally, an example embodiment provides a concept of a sponsored proposition. The idea is instead of the traditional method of a Brand surveying an audience to gain insight. In an embodiment, a brand can just seed what type of insight they are looking for and offer a reward to advocates to create their own survey to gain insights. The advantage here is that people respond differently to branded surveys v.s. unbranded surveys and so the survey will look like it is created by an individual with an added bonus of a gift/reward/give away to participate or win a non-branded survey.

### Machine Architecture

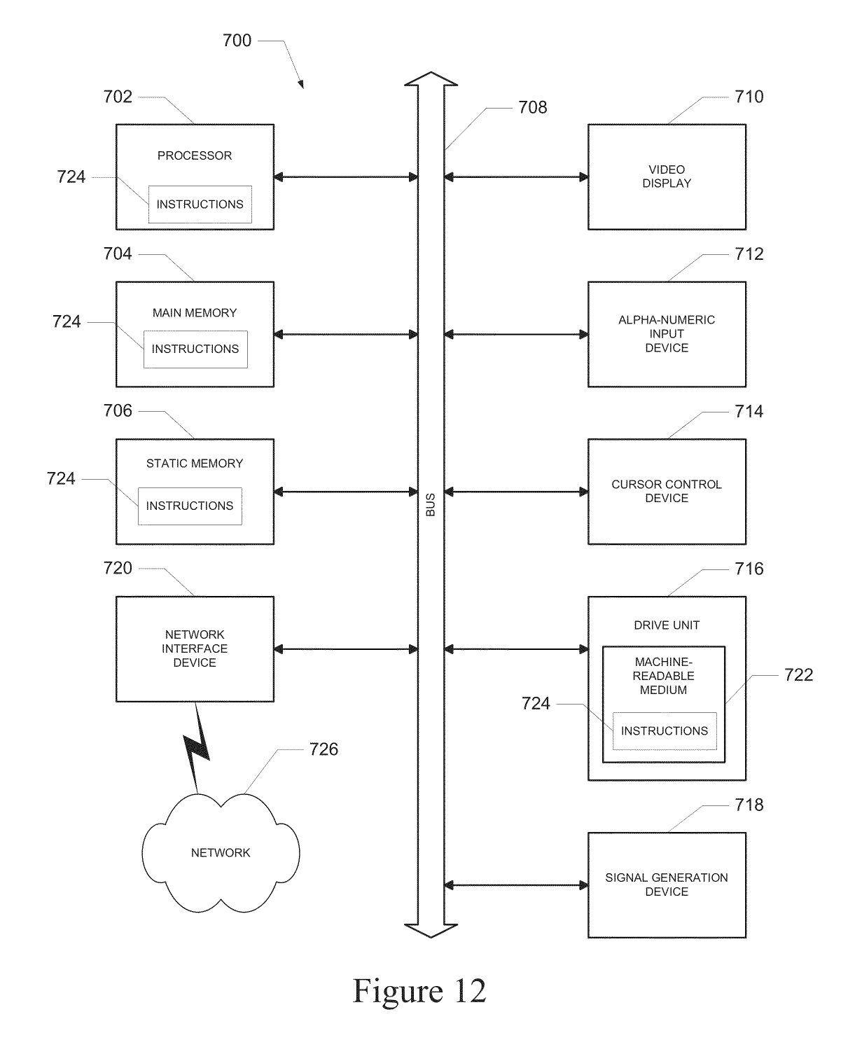

FIG. 12 is a block diagram, illustrating a diagrammatic representation of machine 700, in the example form of a computer system within which a set of instructions, for causing the machine to perform any one or more of the methodologies discussed herein, may be executed. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 may include a processor 702 (e.g., a central processing unit (CPU) a graphics processing unit (GPU) or both), a main memory 704 and a static memory 706, which communicate with each other via a bus 708. The computer system 700 may further include a video display unit 710 (e.g., liquid crystal displays (LCD) or cathode ray tube (CRT)). The computer system 700 also may include an alphanumeric input device 712 (e.g., a keyboard), a cursor control device 714 (e.g., a mouse), a disk drive unit 716, a signal generation device 718 (e.g., a speaker) and a network interface device 720.

The disk drive unit 716 may include a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media. The software 724 may further be transmitted or received over a network 726 via the network interface device 720.

While the machine-readable medium 722 is shown in an example embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any non-transitory medium that is capable of storing, encoding or carrying a set of instructions for execution by the machine and that cause the machine to perform any one or more of the methodologies of the present invention. The term “machine-readable storage medium” shall accordingly be taken to include, but not be limited to, non-transitory solid-state memories and optical and magnetic media.

Thus, systems and methods for creating and managing dynamic propositions for online community feedback are provided. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method comprising:
providing a user interface, by use of a processor, to enable a creator to create a proposition;
inserting tags into variable portions of the proposition to parameterize the proposition;
identifying a target audience for the parameterized proposition; and
publishing the parameterized proposition to the identified target audience.

2. A method comprising:
providing a user interface, by use of a processor, to enable a respondent to receive a parameterized proposition;
prompting the respondent to vote on the parameterized proposition;
logging a vote submitted by the respondent;
enabling the respondent to modify variable portions of the parameterized proposition as identified by tags in the parameterized proposition; and
publishing the modified parameterized proposition to a target audience.

3. A system comprising:
a first user interface to enable a creator to create a proposition, to insert tags into variable portions of the proposition to parameterize the proposition, and to identify a target audience for the parameterized proposition; and
a server to publish the parameterized proposition to the identified target audience.

4. A system comprising:
a first user interface to enable a respondent to receive a parameterized proposition, to prompt the respondent to vote on the parameterized proposition, to log a vote submitted by the respondent, and to enable the respondent to modify variable portions of the parameterized proposition as identified by tags in the parameterized proposition; and
a server to publish the modified parameterized proposition to a target audience.

5. A machine-readable storage medium embodying instructions, the instructions, when executed by a machine, causing the machine to:
provide a user interface to enable a creator to create a proposition;
insert tags into variable portions of the proposition to parameterize the proposition;
identify a target audience for the parameterized proposition; and
publish the parameterized proposition to the identified target audience.

6. A machine-readable storage medium embodying instructions, the instructions, when executed by a machine, causing the machine to:
provide a user interface to enable a respondent to receive a parameterized proposition;
prompt the respondent to vote on the parameterized proposition;
log a vote submitted by the respondent;
enable the respondent to modify variable portions of the parameterized proposition as identified by tags in the parameterized proposition; and
publish the modified parameterized proposition to a target audience.
